(19) United States
(12) Patent Application Publication
(10) Pub. No.: US 2019/0044759 A1
(43) Pub. Date: Feb. 7, 2019

(54) SOFT-INFORMATION MODERATION FOR MIMO DETECTORS

(71) Applicant: University of Utah Research Foundation, Salt Lake City, UT (US)

(72) Inventors: Jonathan Hedstrom, Salt Lake City, UT (US); Yuen Chung, Salt Lake City, UT (US); Behrouz FARHANG-BOROUJENY, Salt Lake City, UT (US)

(21) Appl. No.: 16/061,328

(22) PCT Filed: Dec. 9, 2016
(86) PCT No.: PCT/US16/65994

§ 371 Date: Jun. 11, 2018

Related U.S. Application Data
(60) Provisional application No. 62/386,764, filed on Dec. 10, 2015.
(60) Provisional application No. 62/316,354, filed on Mar. 31, 2016.

(51) Int. Cl. H04L 25/03; H04B 7/0413; H04B 17/336

(52) U.S. Cl. CPC H04L 25/03318; H04B 7/0413; H04J 13/00; H04L 25/03968; H04B 17/336

(57) ABSTRACT

A technology is described for moderating output confidence of output soft information associated with a MIMO detector. An example method can include generating output soft-information that is a measure of likelihood that a subset of bit sequence permutations correctly represents a bit sequence extracted from a radio signal received by the MIMO detector. Calculating a distance of the subset of bit sequence permutations to the bit sequence extracted from the radio signal. Determining that the output confidence of the output soft-information warrants adjustment of the output confidence of the output soft-information based in part on the distance of the bit sequence extracted from the radio signal to the subset of bit sequence permutations. And adjusting the output confidence of the output soft-information based in part on the distance of the bit sequence extracted from the radio signal to the subset of bit sequence permutations using an adjustment technique.

### RELATED APPLICATION(S)

This application claims priority to U.S. Provisional Application No. 62/386,764, filed on Dec. 10, 2015 and U.S. Provisional Application 62/316,354, filed on Mar. 31, 2016, which are incorporated herein by reference.

### GOVERNMENT INTEREST

This invention was made with government support under Grant No. 1449033 awarded by U.S. National Science Foundation. The government has certain rights in the invention.

### BACKGROUND

The goal of recent wireless technology advancements is to increase the spectral efficiency of wireless communications, thus allowing more data to be sent over the same amount of frequency spectrum. This goal may be important because it directly affects the maximum capacity of a wireless network. For example, a cellular network with 200 MHz of licensed bandwidth and 1 bit/s/Hz spectral efficiency can serve a total of 200 Mbps to its users. Assuming 100 users each will be able to use 2 Mbps. suppose a new technology allowed an increase of spectral efficiency to 4 bit/s/Hz. Then the cell carrier could either increase to 400 users or increase each user's cellular speed to 8 Mbps, thereby increasing profits and customer satisfaction.

The wireless industry has been consistently increasing spectral efficiency and capacity of wireless networks for over a hundred years, but it is becoming increasingly difficult to make continued, meaningful progress. One of the last frontiers is to use multiple antennas to simultaneously send data in parallel. This is called spatial-multiplexing MIMO (Multiple Input Multiple Output). MIMO is included in the 802.11n WiFi, 802.11ac WiFi, LTE-advanced, and 5G protocols. A common shorthand when describing MIMO systems is to state the number of transmit and receive antennas in the form Nₜᵣₐₙₛₘᵢₜ×N_{receive}. For example, 8×8 means 8 transmit by 8 receive.

### SUMMARY

A technology is described for moderating output confidence of output soft-information. The technology can moderate the output confidence of output soft-information based in part on a distance of a bit sequence to an expectation of correct bit sequences. Output soft-information can be a measure of a likelihood that a subset of bit sequence permutations correctly represents a bit sequence extracted from a radio signal received by a Multiple-Input and Multiple-Output (MIMO) detector or a Code Division Multiple Access (CDMA) detector. In one example method, output soft-information can be generated and a distance of a bit sequence permutations to an expectation of correct bit sequences can be calculated. A determination can then be made whether the output confidence of the output soft-information warrants adjustment of the output confidence of the output soft-information based in part on the distance of the bit sequence to the expectation of correct bit sequences. In the case that output confidence of the output soft-information warrants adjustment, the output confidence of the output soft-information can be adjusted based in part on the distance of the bit sequence to the expectation of correct bit sequences using an adjustment technique. There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a block diagram illustrating an example system for processing a radio signal using a MIMO detector configured to moderate output confidence of output soft-information.

FIG. 2 is a flow diagram that illustrates an example method for moderating output confidence of output soft-information.

FIG. 3 is block diagram illustrating an example of a computing device that can be used to execute a method for moderating output confidence of output soft-information.

FIG. 4 illustrates a diagram of a wireless device (e.g., UE) and a base station (e.g., eNodeB) in accordance with an example.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a detector” includes reference to one or more of such materials and reference to “adjusting” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “processor” can include general purpose processors, specialized processors such as very-large-scale integration (VLSI), field-programmable gate arrays (FPGAs), or other types of specialized processors, as well as base band processors used in transceivers to send, receive, and process wireless communications. Some of the functional units described herein have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components.

A module may also be implemented in programmable hardware devices such as FPGAs, programmable array logic, programmable logic devices or the like.

As used herein, the term “memory” and “memory device” can include devices which store data including, but not limited to, RAM, ROM, cache, registers, flip-flops, latches, and specialized circuits and devices for storage of data or processor instructions.

As used herein, the term “memory device with instructions” can be devices which can be used to control a processor and can include a specialized circuit, module, or programmable device which is configured to directly execute the process that would be controlled by the memory device with instructions.

Multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be integrated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, and combinations of each (e.g. A+B, B+C, A+C, and A+B+C).

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

A primary reason why MIMO has only recently been used to increase spectral efficiency is that it's computationally difficult. At the receiver the parallel signals are mixed together, requiring a large amount of processing to separate. This digital signal processing (DSP) to separate the mixed signals is called the “detector”. Sometimes a detector is referred to as a “decoder”, which may be confused with a processing step called “decoding” (e.g. LDPC decoder and convolutional decoder). As used herein, the method of separating radio signals is referred to as a “detector” and the method of undoing error correction code will be the “decoder”.

General MIMO Detector Overview.

MIMO Model.

A typical SISO (signal input single output) one stream wireless system can be modeled by the Eq. 1, where y is the received signal, h is the attenuation and delay of the signal moving from transmitter to receiver through a flat fading channel, s is the original transmitted signal, and n is additive white Gaussian noise (AWGN), Eq. 1 with variance per complex element of σₙ².

y=hs+n (1)

The simple 1 antenna SISO model can be expanded to MIMO by making all variables vectors except for the channel which becomes the matrix H, Eq. 2. The channel matrix represents the attenuation and delay between each pair of transmit and receive antennas.

y=Hs+n (2)

Zero-Forcing and MMSE Detector.

Generally assumed is that an arbitrarily good estimate of a channel matrix H exists. This is reasonable because real-world wireless protocols specify that a known training sequence of sufficient length be placed in the header. Thus it is possible to use simple linear algebra to solve the MIMO separation problem at the receiver by applying the channel inverse H⁻¹ or pseudo-inverse to get an estimate of the transmitted signal ŝ.

ŝ=H⁻¹y=s+H⁻¹n [symbol] (3)

Notice that the estimate includes an error term H⁻¹n. If the original channel matrix H is ill-conditioned, which is often true, then the inverse of the original channel matrix H will likely have entries with large magnitude. These large values apply gain to the noise vector. Thus this inverse method called zero forcing (ZF) suffers from a degrading effect referred to as noise enhancement. A common way to mitigate the degrading effect is to instead use a modified minimum mean square error (MMSE) version of the channel inverse. MMSE attempts to reduce noise enhancement without adding too much error by not being a perfect inverse. These two methods are simple and low cost but also have poor performance.

Maximum Likelihood (ML) and MAP Detector

The theoretically best approach to solving the signal separation issue is the ML detector. The idea is to check every possible transmitted signal s, apply the known channel, and select the option which is closest to the received signal.

ŝ=argmin_{\tilde{s}}(∥y−H\tilde{s}∥) [symbol] (4)

Although this method provides good performance, the method's exponentially growing complexity generally makes it useful only for comparison purposes and not for application. For example, the largest MIMO size in the 802.11ac WiFi protocol is 8×8 (i.e., 8 transmit by 8 receive antennas) with 256 QAM. This means that 8 [symbol] bg₂(256)=64 bits [symbol] are transmitted simultaneously with 2⁶⁴≈18e18 possible permutations. Testing all 18 billion billion possibilities is not currently possible in practical application.

There is a related method called the maximum a posteriori (MAP) detector which includes information known from a previous processing step to the decision about which bit sequence is best. Most commonly this is used inside of turbo equalization loops.

Approximate-ML and Approximate-MAP Detectors.

There are many methods which find a small subset of the permutation list to search across, of which the method chooses the solution closest to the received sequence. Because of the similarity to ML, this broad category is often referred to as approximate-ML detectors (or approximate-MAP if prior information is available). Approximate-ML detectors generally have a somewhat adjustable performance in between MMSE and ML dependent on how large their search list is. Prominent examples in the published literature and in industry are sphere-decoding, k-best, and MCMC.

Sphere-decoding checks all permutations within a given distance from a starting point. If one thinks of this in a three dimensional space with the distance parameter as a radius, then it is intuitive to think of it as a sphere being searched within. The problem is that as the signal-to-noise ratio (SNR) becomes lower the radius must increase, dramatically increasing complexity. The dimension of the sphere increases as the number of antennas and QAM size increases as well. Thus it is well known that although sphere-decoding's performance can be quite good and with reasonable complexity at small MIMO sizes, it still has an exponentially increasing complexity which makes it infeasible for larger MIMO. Also, note the confusing terminology referring to a detector as “decoding” for historical reasons.

K-best (breadth-first version of sphere-decoding) shares ideas with sphere-decoding and tree-search. K-best has a parameter K which must be increased in size with increasing number of antennas and QAM. K-best also suffers from an exponentially increasing complexity.

Markov Chain Monte Carlo (MCMC) and excited-MCMC (X-MCMC) performs an intelligent random walk. MCMC and X-MCMC display high performance with low complexity.

Interference Cancellation Detectors.

There are many varieties of interference cancelling detectors. Interference cancelling detectors can generally be thought of as a hybrid class which combines one of the other detector methods with a loop. Each iteration recursively improves the result by removing interference from what was discovered in a previous iteration. These methods can have a low complexity, but in order to get close to ML performance, the complexity and number of iterations may need to be increased dramatically.

Turbo Loops.

A turbo loop is the combination of a detector capable of using prior information (most methods except for ZF/MMSE/ML) with a decoder in a loop, exchanging information on each iteration to improve the result. Turbo loops are capable of extremely high performance but the increased processing delay and complexity generally make them difficult to use in practice. Note that some encoding schemes combine two different codes, thus making it possible to use a turbo loop inside of just the decoder, but this doesn't preclude the additional use of an outer turbo loop combining such a decoder with a detector in a known fashion.

Soft Information and LLR.

In a MIMO communication systems, data often needs to flow between detectors and decoders. This can be in the form of hard-decisions, meaning binary 1's and 0's which are the receiver's estimates of the transmitted sequence, but this does not accurately represent the full knowledge of the bits. For example, when passing hard decisions it may not be possible for the detector to tell the decoder with 100% certainty what a bit is versus having some uncertainty what a bit is. For that reason soft-decision data exists.

If a binary zero is represented as −1 and a binary one as +1, then the confidence in the information can be easily represented by negative and positive magnitude, with 0 meaning complete uncertainty. This allows much more detail to be passed between detectors and decoders resulting in a large performance boost. In practice it is typical to use logarithmic representations because it simplifies the required math. For that reason soft-information is also commonly referred to as the log likelihood ratio (LLR) because it represents the ratio of likelihoods of a bit being a 1 or 0 in logarithmic form.

In the case that soft-information is an input to a function, the soft-information is called a priori information or just the prior. The output soft-information can be referred to as “full” if the output soft-information includes the prior, or extrinsic if the output soft-information only includes newly calculated information. Most often the extrinsic information is passed as the next stage's prior. Full information is often used to generate final hard decisions.

When an ML detector is derived, the output LLR takes the form of Eq. 5 after a max-log approximation is used. This means that for the k^{th} bit, the permutation with bₖ=+1 mapped to ŝ closest to the received y is subtracted from the smallest distance with bₖ=−1. In an example where both distances are equivalent, this means that neither 0 or 1 is preferred, resulting in the soft-information being passed is zero, thus the soft-information is uncertain about the bit.

$$LLR ( k ) \approx {min}_{{χ}^{k -}} ( \frac{\vert \vert y - H \hat{s} {\vert \vert}^{2}}{{σ}_{n}^{2}} ) - {min}_{{χ}^{k +}} ( \frac{\vert \vert y - H \hat{s} {\vert \vert}^{2}}{{σ}_{n}^{2}} ) \qquad ( 5 )$$

where the minimum is taken over [symbol] ^{k-}, the list of all permutations of ŝ mapped with bₖ=−1, and [symbol] ^{k+}, the list of all permutations of s mapped with bₖ=+1.

For a maximum a posteriori (MAP) detector, additional variables can be added to include prior information in the computation of the output extrinsic information, as in Eq. 6. Here \k is set notation for a vector with the k^{th} element removed, b is the current permutation's bit sequence taking values +/−1, and λ^{a} is the prior.

$${L}^{e} ( k ) \approx {min}_{{χ}^{k -}} ( \frac{\vert \vert y - H \hat{s} {\vert \vert}^{2}}{{σ}_{n}^{2}} - {b}_{\backslash k} \cdot {λ}_{\backslash k}^{a} ) - {min}_{{χ}^{k +}} ( \frac{\vert \vert y - H \hat{s} {\vert \vert}^{2}}{{σ}_{n}^{2}} - {b}_{\backslash k} \cdot {λ}_{\backslash k}^{a} ) \qquad ( 6 )$$

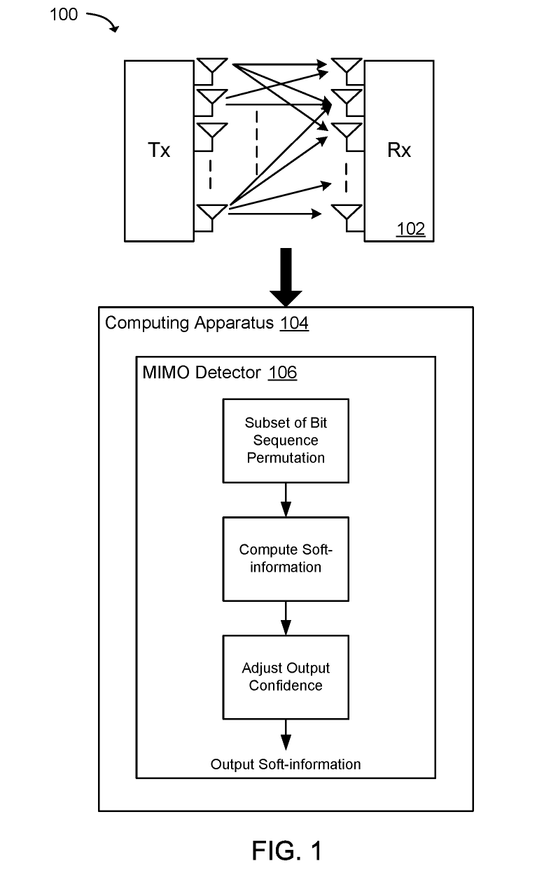

FIG. 1 is a block diagram illustrating a high level example of a system 100 on which the present technology can be executed. Illustrated is a MIMO configuration 102 (providing a visual representation of channel matrix H with connecting arrows representing complex elements of signal strength and phase delay) that is communicatively connected to a computing apparatus 104 configured to execute a MIMO detector 106. With conventional list based MIMO detectors, ML and MAP soft-output Eqs. 5 and 6 are commonly used. This is because when many of the approximate-ML methods, such as MCMC, sphere-decoding, or k-best explore a large enough subset, the Eqs. 5 and 6 can use the same derivations as ML and MAP to derive the same equation for their soft-output. The problem with this approach is that it only works when a statistically large subset of all permutations is explored. If the size of the subset is too small, or when the subset is biased, then the statistics break down and the output can produce wrong results.

Since the goal of approximate-ML detectors is to create a high performance output with as small a subset as possible, the LLR calculation breakdown can be encountered for any viable low complexity method. Suppose a MIMO detector is designed which 99% of the time produces good results, but 1% of the time is lost and never gets close to a correct solution. Suppose further that a typical good solution has distances of 1 for the correct bit and 2 for the incorrect bit solution, thus the output LLR would be 1−2=−1. Now consider the bad solution. If the solution has distances of 20 for the correct bit and 10 for the incorrect bit, then the output LLR would be 20−10=10. Notice that the confidence in the bad solution is 10× larger than in the good case. When typical simple analysis using hard-decision based bit-error-rate (BER) plots are used on detectors, the bias has no effect, but when this bad soft-information is passed from the detector to the decoder, bad soft-information may contaminate other bits to create a large number of errors.

The present technology improves the output LLR by detecting when a correct answer is not in the subset of permutations checked and adjusting the output confidence accordingly. To detect how close the current estimate is to the optimal one, the distance metric is used. As can be seen in Eq. 7, the expectation of correct bit sequences is Nᵣσₙ² [symbol] where Nᵣ is the number of receive antennas. Therefore, in Eq. 8, the ratio of the current bit sequence's distance to the expected correct solution, can be used to measure the confidence that the correct bit sequence was observed in the list Z, the list of all checked, sampled, observed, calculated, or estimated transmitted bit sequences \hat{b} and their mapped counterpart ŝ. This list may optionally including the hard decision on the output LLR.

$$\begin{matrix}E [ \vert \vert y - Hs {\vert \vert}^{2} ] = {N}_{r} {σ}_{n}^{2} & ( 7 ) \\ δ = {min}_{𝒵} ( \frac{\vert \vert y - H \hat{s} {\vert \vert}^{2}}{{N}_{r} {σ}_{n}^{2}} ) & ( 8 )\end{matrix}$$

The δ metric can be used to improve the output LLR's in many ways. The δ metric can be used with a threshold to zero out a bit sequence which did not get close enough to a reasonable solution. The δ metric can be applied directly to σₙ² in Eqs. 9 and 10. The δ metric can be applied to both σₙ² and λ^{a} in Eq. 11. The δ metric can also be adjusted in strength or behavior by simple manipulations such as limiting to >1, limiting to less than a constant, linearly scaling by a constant coefficient to increase or decrease effect, adding a constant, integrating over time, passing through a shaping function, or passing through a shaping look-up-table.

$$\begin{matrix} LLR ( k ) \approx {min}_{{𝒵}^{k -}} ( \frac{\vert \vert y - H \hat{s} {\vert \vert}^{2}}{{δσ}_{n}^{2}} ) - {min}_{{𝒵}^{k +}} ( \frac{\vert \vert y - H \hat{s} {\vert \vert}^{2}}{{δσ}_{n}^{2}} ) & ( 9 ) \\ {L}^{e} ( k ) \approx {min}_{{𝒵}^{k -}} ( \frac{\vert \vert y - H \hat{s} {\vert \vert}^{2}}{{δσ}_{n}^{2}} - {b}_{\backslash k} \cdot {λ}_{\backslash k}^{a} ) - {min}_{{𝒵}^{k +}} ( \frac{\vert \vert y - H \hat{s} {\vert \vert}^{2}}{{δσ}_{n}^{2}} - {b}_{\backslash k} \cdot {λ}_{\backslash k}^{a} ) & ( 10 ) \\ {L}^{e} ( k ) \approx {min}_{{𝒵}^{k -}} ( \frac{\vert \vert y - H \hat{s} {\vert \vert}^{2}}{{σ}_{n}^{2}} - {b}_{\backslash k} \cdot \frac{{λ}_{\backslash k}^{a}}{δ} ) - {min}_{{𝒵}^{k +}} ( \frac{\vert \vert y - H \hat{s} {\vert \vert}^{2}}{{σ}_{n}^{2}} - {b}_{\backslash k} \cdot \frac{{λ}_{\backslash k}^{a}}{δ} ) & ( 11 )\end{matrix}$$

where the minimum is taken over [symbol] ^{k-}, the list of all checked, sampled, observed, calculated, or estimated transmitted bit sequences \hat{b} with bₖ=−1 and their mapped counterparts ŝ, and [symbol] ^{k+}, as in [symbol] ^{k-} but ŝ mapped with bₖ+1.

For detector methods that do not use a search across a subset of permutations, the present technology can still be used. These detector methods include ZF, MMSE, interference cancellation, and others which produce an estimate ŝ directly rather than first computing an estimate of \hat{b}. These detector methods generally derive the soft-information based on the probability of a specific bit being a 1 or 0 given the spatial location of ŝ in the symbol constellation. In this situation, the distance ∥y−Hŝ∥² can be calculated directly or by first making a hard decision, mapping to ŝ, and then calculating the distance. The methods used to calculate δ are then followed as specified earlier and then applied as in Eq. 12.

$${L}_{improved} ( k ) = \frac{1}{δ} {L}_{original} ( k ) \qquad ( 12 )$$

This has been a heuristic explanation of δ but it can also be derived directly by conditioning the probabilities on the confidence in the list, if using a list based method, or the final solution, if not using a list based method. If one assumes that the best solution of the list still has some bit errors, then the errors can be modeled with a Gaussian distribution of variance σ_{b}² which is independent of noise with variance σₙ². This statistical method of deriving the output scaling is an alternative to the heuristic explanation, as in Eq. 13.

σₙ²+σ_{b}²=δσₙ² [symbol] (13)

Next, to use this statistical method an estimate of (σₙ²+σ_{b}²) is needed. Any standard statistical method can be used which utilizes samples of the distance ∥y−Hŝ∥² to estimate the combination of noise and bit-error variance. One exemplary method is to simply use the minimum distance of the list [symbol] , the list of all checked, sampled, observed, calculated, or estimated transmitted bit sequences \hat{b} and their mapped counterpart ŝ optionally including the hard decision on the output LLR, as in Eq. 14.

$${σ}_{n}^{2} + {σ}_{b}^{2} \approx \frac{{min}_{𝒵} ( \vert \vert y - H \hat{s} {\vert \vert}^{2} )}{{N}_{r}} \qquad ( 14 )$$

The minimum is also an appropriate approximation when the list length is one, as in non-list based methods.

The present technology described above can be used on any MIMO detector by computing the best estimate's closeness to the expectation of correct solutions. For example and without exclusion, it can be used with MCMC, sphere-decoding, k-best, tree-search, ZF, MMSE, interference cancellation, and others. The present technology is compatible with using a priori information and is easily implemented in a field-programmable gate array (FPGA) and silicon designs. The present technology provides improvements in performance, which also translates into a reduced complexity and cost receiver.

In one example, output soft-information for MIMO and CDMA detectors can be improved using a measure of closeness of a best estimate to a correct signal and adjusting the strength of the output soft-information accordingly. The output soft-information can be extrinsic. The output soft-information can be full.

The measure δ of the closeness of the best estimate to the true transmitted signal can use the best estimate. In one example, the best estimate can be the final bit-sequence estimate \hat{b}. In another example, the best estimate can be the final symbol estimate ŝ. In another example, the best estimate can be the best visited bit-sequence estimate \hat{b}. In yet another example, the best estimate can be the best visited symbol estimate ŝ.

In one example, δ can be the ratio between the best distance and the expected true transmitted signals distance. Distance can be the magnitude squared difference between the received signal and the best estimate as in ∥y−Hŝ∥². Distance can be the magnitude difference between the received signal and the best estimate, ∥y [symbol] Hŝ∥. [symbol] Distance can be an estimate of the magnitude or magnitude squared, but without restriction, where magnitude=α [symbol] ax(|I|, |Q|)+β [symbol] in(|I|, |Q|) where I and Q are real and imagine components and (α, β) are constant coefficients, such as (1, ½) adjusted for estimate accuracy. Distance can be a more convenient form of the difference between the received signal and the best estimate.

In one example, the strength (i.e. confidence) of soft-information can be adjusted according to the closeness of the best estimate. A different adjustment may be made to intrinsic and extrinsic information. The adjustment can be made by directly applying 1/δ to soft-information values. The adjustment can be made by directly applying

$$\frac{1}{f ( δ )}$$

to the soft-information values. In one example, the f( [symbol] ) can be a transformation function used to optimize the improvement made to the soft-information. In another example, the f( [symbol] ) can be any combination of changes to δ. In another example, the f( [symbol] ) can be a linear scaling function. In another example, the f( [symbol] ) can be any polynomial scaling function. In another example, the f( [symbol] ) can be a look-up-table. In yet another example, the f( [symbol] ) can limit the input to specific extreme values.

In one example, soft-information moderation can be applied to any MIMO or CDMA detector which is used to separate a received signal into multiple streams. Examples can include: MCMC, sphere-decoding, k-best, tree-search, interference cancellation, MMSE, and zero-forcing.

In one example, performance of a communication system can be improved by using the measure δ of closeness not only at final output, but also within the detector's algorithm itself. The detector can be any detector. The detector can be any variation of k-best. The measure of closeness can be used to detect a problem and trigger problem mitigation. The measure of closeness can be used to detect an early reasonable solution in order to skip unnecessary calculations. The measure of closeness can be used to trigger an abortion of the method to save time and power. The measure of closeness can be used to trigger an increase in effort. The measure of closeness can be used to trigger a go-back to a previous step to calculate a different set of possible solutions.

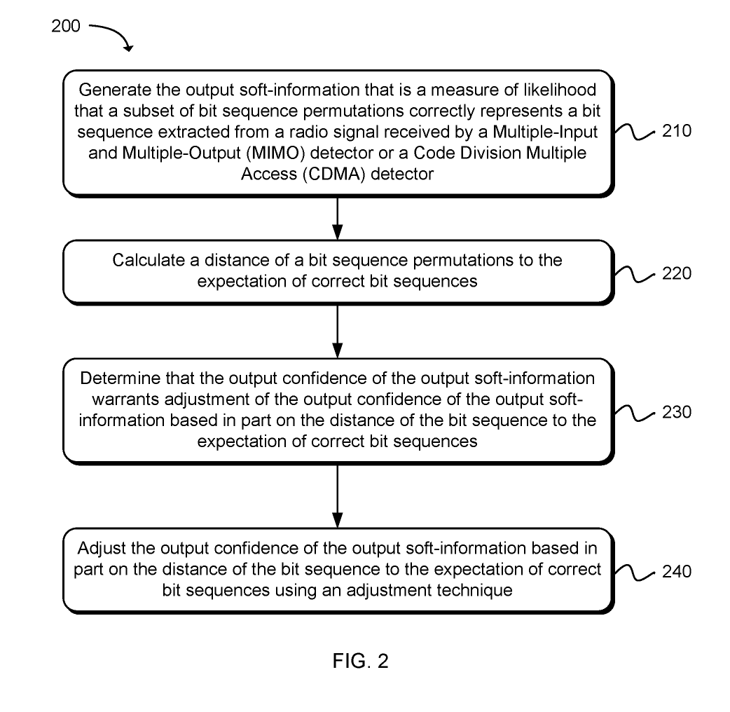

FIG. 2 is a flow diagram illustrating an example method 200 for moderating output confidence of output soft-information in a radio signal detector, such as a MIMO detector or a Code Division Multiple Access (CDMA). The radio signal detector can be configured to separate a radio signal received at the radio signal detector into multiple data streams. For example, the radio signal detector can be configured to use at least one of: Markov Chain Monet Carlo (MCMC), sphere-decoding, k-best, tree-search, interference cancellation, Minimum Mean-Squared Error (MMSE), or zero-forcing to separate the radio signal into multiple data streams.

As in block 210, output soft-information can be generated where the soft-information can be a measure of likelihood that a subset of bit sequence permutations correctly represents a bit sequence extracted from the radio signal received by a radio signal detector. In one example, the output soft-information can be extrinsic, where new information is used to generate the output soft-information. In another example, the output soft-information can be full output soft-information using prior input soft-information.

As in block 220, a distance of a bit sequence to the expectation of correct bit sequences can be calculated. In one example, the output confidence of the output soft-information can be measured by calculating a ratio for the distance of the bit sequence to the expectation of correct bit sequences. Calculating the ratio can include classifying incorrect bits included in the subset of bit sequence permutations as noise that can be added to additive white Gaussian noise. In one example, the distance can be a magnitude difference between the bit sequences to the expectation of correct bit sequences. In another example, the distance can be a magnitude squared difference between the bit sequence to the expectation of correct bit sequences. In yet another example, the distance can be an estimate of a magnitude or a magnitude squared, where magnitude=α [symbol] ax(|I|, |Q|)+β [symbol] in(|I|, |Q|), and where I and Q are real and imagine components, and α and β are constant coefficients adjusted for estimate accuracy.

As in block 230, a determination may be made that the output confidence of the output soft-information warrants adjustment of the output confidence of the output soft-information based in part on the distance of the bit sequence to the expectation of correct bit sequences. For example, this determination may be made by using Eq. 8 and a threshold of δ>1.

As in block 240, the output confidence of the output soft-information can be adjusted based in part on the distance of the bit sequence to the expectation of correct bit sequences using an adjustment technique. In one example, the adjustment technique can directly apply

$$\frac{1}{δ}$$

to output soft-information values. In another example, the adjustment technique can directly apply

$$\frac{1}{f ( δ )}$$

to output soft-information values. In another example, the adjustment technique can use the distance in conjunction with a threshold to zero out the subset of bit sequence permutations. In some examples, the adjustment technique can utilize a transformation function to adjust output confidence of the output soft-information. The transformation function can pass the output confidence of the output soft-information through a shaping function or a shaping look-up table.

In another example, the output confidence of the soft-information can be adjusted based in part on the distance of the bit sequence to the expectation of correct bit sequences using a scaling function. The scaling function can be a linear scaling function or a polynomial scaling function.

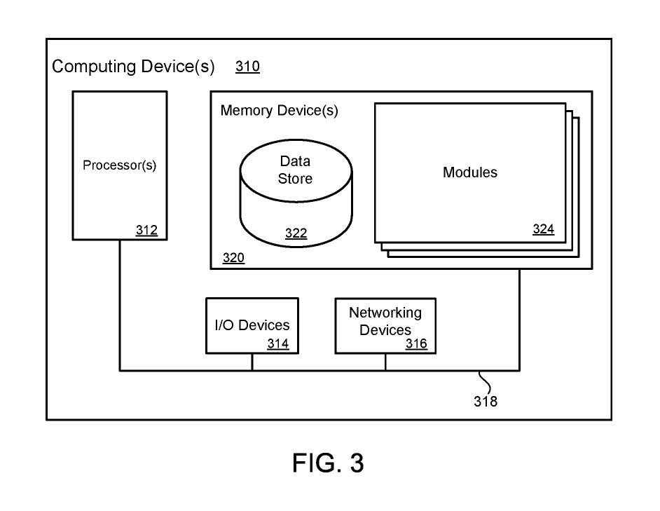

FIG. 3 illustrates a computing device 310 on which modules of this technology can execute. A computing device 310 is illustrated on which a high level example of the technology can be executed. The computing device 310 can include one or more processors 312 that are in communication with memory devices 320. The computing device 310 can include a local communication interface 318 for the components in the computing device. For example, the local communication interface 318 can be a local data bus and/or any related address or control busses as may be desired.

The memory device 320 can contain modules 324 that are executable by the processor(s) 312 and data for the modules 324. The modules 324 can execute the functions described earlier. A data store 322 can also be located in the memory device 320 for storing data related to the modules 324 and other applications along with an operating system that is executable by the processor(s) 312.

Other applications can also be stored in the memory device 320 and can be executable by the processor(s) 312. Components or modules discussed in this description that may be implemented in the form of software using high programming level languages that are compiled, interpreted or executed using a hybrid of the methods.

The computing device may also have access to I/O (input/output) devices 314 that are usable by the computing devices. Networking devices 316 and similar communication devices may be included in the computing device. The networking devices 316 can be wired or wireless networking devices that connect to the internet, a LAN, WAN, or other computing network.

The components or modules that are shown as being stored in the memory device 320 can be executed by the processor(s) 312. The term “executable” may mean a program file that is in a form that can be executed by a processor 312. For example, a program in a higher level language can be compiled into machine code in a format that may be loaded into a random access portion of the memory device 320 and executed by the processor 312, or source code may be loaded by another executable program and interpreted to generate instructions in a random access portion of the memory to be executed by a processor. The executable program can be stored in any portion or component of the memory device 320. For example, the memory device 320 can be random access memory (RAM), read only memory (ROM), flash memory, a solid state drive, memory card, a hard drive, optical disk, floppy disk, magnetic tape, or any other memory components.

The processor 312 can represent multiple processors and the memory device 320 can represent multiple memory units that operate in parallel to the processing circuits. This can provide parallel processing channels for the processes and data in the system. The local interface 318 can be used as a network to facilitate communication between any of the multiple processors and multiple memories. The local interface 318 can use additional systems designed for coordinating communication such as load balancing, bulk data transfer, and similar systems.

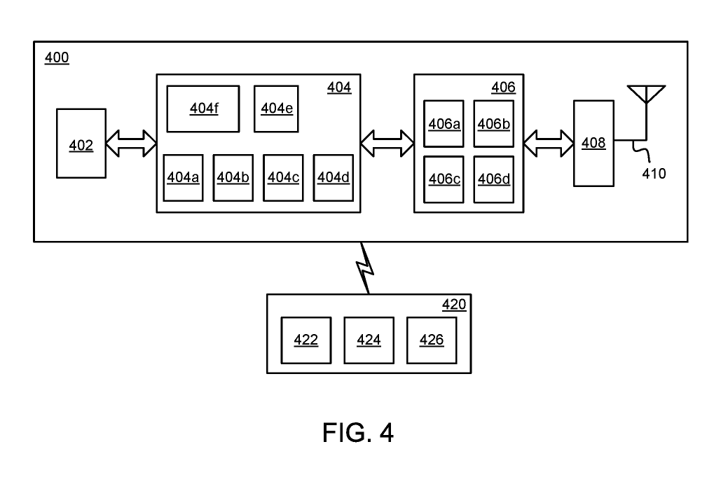

FIG. 4 provides an example illustration of a user equipment (UE) device 400 and a node 420. The UE device 400 and node 420 illustrate devices on which the technology described herein can be used. The UE device 400 can include a wireless device, a mobile station (MS), a mobile wireless device, a mobile communication device, a tablet, a handset, or other type of wireless device. The UE device 400 can include antennas configured to communicate with the node 420 or transmission station, such as a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or other type of wireless wide area network (WWAN) access point. The node 420 can include one or more processors 422, memory 424 and a transceiver 426. The UE device 400 can be configured to communicate using at least one wireless communication standard including 3GPP LTE, WiMAX, High Speed Packet Access (HSPA), Bluetooth, and WiFi. The UE device 400 can communicate using separate antennas for each wireless communication standard or shared antennas for multiple wireless communication standards. The UE device 400 can communicate in a wireless local area network (WLAN), a wireless personal area network (WPAN), and/or a WWAN.

In some embodiments, the UE device 400 can include application circuitry 402, baseband circuitry 404, Radio Frequency (RF) circuitry 406, front-end module (FEM) circuitry 408 and one or more antennas 410, coupled together at least as shown. In addition, the node 420 can include, similar to that described for the UE device 400, application circuitry, baseband circuitry, Radio Frequency (RF) circuitry, front-end module (FEM) circuitry and one or more antennas

The application circuitry 402 can include one or more application processors. For example, the application circuitry 402 can include circuitry such as, but not limited to, one or more single-core or multi-core processors. The processor(s) can include any combination of general-purpose processors and dedicated processors (e.g., graphics processors, application processors, etc.). The processors can be coupled with and/or can include a storage medium, and can be configured to execute instructions stored in the storage medium to enable various applications and/or operating systems to run on the system.

The baseband circuitry 404 can include circuitry such as, but not limited to, one or more single-core or multi-core processors. The baseband circuitry 404 can include one or more baseband processors and/or control logic to process baseband signals received from a receive signal path of the RF circuitry 406 and to generate baseband signals for a transmit signal path of the RF circuitry 406. Baseband processing circuitry 404 can interface with the application circuitry 402 for generation and processing of the baseband signals and for controlling operations of the RF circuitry 406. For example, in some embodiments, the baseband circuitry 404 can include a second generation (2G) baseband processor 404a, third generation (3G) baseband processor 404b, fourth generation (4G) baseband processor 404c, and/or other baseband processor(s) 404d for other existing generations, generations in development or to be developed in the future (e.g., fifth generation (5G), 6G, etc.). The baseband circuitry 404 (e.g., one or more of baseband processors 404a-d) can handle various radio control functions that enable communication with one or more radio networks via the RF circuitry 406. The radio control functions can include, but are not limited to, signal modulation/demodulation, encoding/decoding, radio frequency shifting, etc. In some embodiments, modulation/demodulation circuitry of the baseband circuitry 404 can include Fast-Fourier Transform (FFT), precoding, and/or constellation mapping/demapping functionality. In some embodiments, encoding/decoding circuitry of the baseband circuitry 404 can include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 404 can include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 404e of the baseband circuitry 404 can be configured to run elements of the protocol stack for signaling of the PHY, MAC, RLC, PDCP and/or RRC layers. In some embodiments, the baseband circuitry can include one or more audio digital signal processor(s) (DSP) 404f. The audio DSP(s) 104f can be include elements for compression/decompression and echo cancellation and can include other suitable processing elements in other embodiments. Components of the baseband circuitry can be suitably combined in a single chip, a single chipset, or disposed on a same circuit board in some embodiments. In some embodiments, some or all of the constituent components of the baseband circuitry 404 and the application circuitry 402 can be implemented together such as, for example, on a system on a chip (SOC).

In some embodiments, the baseband circuitry 404 can provide for communication compatible with one or more radio technologies. For example, in some embodiments, the baseband circuitry 404 can support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 404 is configured to support radio communications of more than one wireless protocol may be referred to as multi-mode baseband circuitry.

The RF circuitry 406 can enable communication with wireless networks using modulated electromagnetic radiation through a non-solid medium. In various embodiments, the RF circuitry 406 can include switches, filters, amplifiers, etc. to facilitate the communication with the wireless network. RF circuitry 406 can include a receive signal path which can include circuitry to down-convert RF signals received from the FEM circuitry 408 and provide baseband signals to the baseband circuitry 404. RF circuitry 406 can also include a transmit signal path which can include circuitry to up-convert baseband signals provided by the baseband circuitry 404 and provide RF output signals to the FEM circuitry 408 for transmission.

In some embodiments, the RF circuitry 406 can include a receive signal path and a transmit signal path. The receive signal path of the RF circuitry 406 may include mixer circuitry 406a, amplifier circuitry 406b and filter circuitry 406c. The transmit signal path of the RF circuitry 406 may include filter circuitry 406c and mixer circuitry 406a. RF circuitry 406 may also include synthesizer circuitry 406d for synthesizing a frequency for use by the mixer circuitry 406a of the receive signal path and the transmit signal path. In some embodiments, the mixer circuitry 406a of the receive signal path may be configured to down-convert RF signals received from the FEM circuitry 408 based on the synthesized frequency provided by synthesizer circuitry 406d. The amplifier circuitry 406b may be configured to amplify the down-converted signals and the filter circuitry 406c may be a low-pass filter (LPF) or band-pass filter (BPF) configured to remove unwanted signals from the down-converted signals to generate output baseband signals. Output baseband signals may be provided to the baseband circuitry 404 for further processing. In some embodiments, the output baseband signals may be zero-frequency baseband signals, although this is not a necessity. In some embodiments, mixer circuitry 406a of the receive signal path may comprise passive mixers, although the scope of the embodiments is not limited in this respect.

In some embodiments, the mixer circuitry 406a of the transmit signal path can be configured to up-convert input baseband signals based on the synthesized frequency provided by the synthesizer circuitry 406d to generate RF output signals for the FEM circuitry 408. The baseband signals may be provided by the baseband circuitry 404 and may be filtered by filter circuitry 406c. The filter circuitry 406c may include a low-pass filter (LPF), although the scope of the embodiments is not limited in this respect.

In some embodiments, the mixer circuitry 406a of the receive signal path and the mixer circuitry 406a of the transmit signal path may include two or more mixers and can be arranged for quadrature down-conversion and/or up-conversion respectively. In some embodiments, the mixer circuitry 406a of the receive signal path and the mixer circuitry 406a of the transmit signal path can include two or more mixers and may be arranged for image rejection (e.g., Hartley image rejection). In some embodiments, the mixer circuitry 406a of the receive signal path and the mixer circuitry 406a can be arranged for direct down-conversion and/or direct up-conversion, respectively. In some embodiments, the mixer circuitry 406a of the receive signal path and the mixer circuitry 406a of the transmit signal path can be configured for super-heterodyne operation.

In some embodiments, the output baseband signals and the input baseband signals can be analog baseband signals, although the scope of the embodiments is not limited in this respect. In some alternate embodiments, the output baseband signals and the input baseband signals can be digital baseband signals. In these alternate embodiments, the RF circuitry 406 can include analog-to-digital converter (ADC) and digital-to-analog converter (DAC) circuitry and the baseband circuitry 404 can include a digital baseband interface to communicate with the RF circuitry 406.

In some dual-mode embodiments, a separate radio IC circuitry can be provided for processing signals for each spectrum, although the scope of the embodiments is not limited in this respect.

In some embodiments, the synthesizer circuitry 406d can be a fractional-N synthesizer or a fractional N/N+1 synthesizer, although the scope of the embodiments is not limited in this respect as other types of frequency synthesizers may be suitable. For example, synthesizer circuitry 406d may be a delta-sigma synthesizer, a frequency multiplier, or a synthesizer comprising a phase-locked loop with a frequency divider.

The synthesizer circuitry 406d can be configured to synthesize an output frequency for use by the mixer circuitry 406a of the RF circuitry 406 based on a frequency input and a divider control input. In some embodiments, the synthesizer circuitry 406d can be a fractional N/N+1 synthesizer.

In some embodiments, frequency input can be provided by a voltage controlled oscillator (VCO), although that is not a necessity. Divider control input can be provided by either the baseband circuitry 404 or the applications processor 402 depending on the desired output frequency. In some embodiments, a divider control input (e.g., N) can be determined from a look-up table based on a channel indicated by the applications processor 402.

Synthesizer circuitry 406d of the RF circuitry 406 can include a divider, a delay-locked loop (DLL), a multiplexer and a phase accumulator. In some embodiments, the divider can be a dual modulus divider (DMD) and the phase accumulator can be a digital phase accumulator (DPA). In some embodiments, the DMD can be configured to divide the input signal by either N or N+1 (e.g., based on a carry out) to provide a fractional division ratio. In some example embodiments, the DLL can include a set of cascaded, tunable, delay elements, a phase detector, a charge pump and a D-type flip-flop. In these embodiments, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 406d can be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency can be a LO frequency (fLO). In some embodiments, the RF circuitry 406 can include an IQ/polar converter.

FEM circuitry 408 can include a receive signal path which can include circuitry configured to operate on RF signals received from one or more antennas 410, amplify the received signals and provide the amplified versions of the received signals to the RF circuitry 406 for further processing. FEM circuitry 408 can also include a transmit signal path which can include circuitry configured to amplify signals for transmission provided by the RF circuitry 406 for transmission by one or more of the one or more antennas 410.

In some embodiments, the FEM circuitry 408 can include a TX/RX switch to switch between transmit mode and receive mode operation. The FEM circuitry can include a receive signal path and a transmit signal path. The receive signal path of the FEM circuitry can include a low-noise amplifier (LNA) to amplify received RF signals and provide the amplified received RF signals as an output (e.g., to the RF circuitry 406). The transmit signal path of the FEM circuitry 408 can include a power amplifier (PA) to amplify input RF signals (e.g., provided by RF circuitry 406), and one or more filters to generate RF signals for subsequent transmission (e.g., by one or more of the one or more antennas 410.

Various techniques, or certain aspects or portions thereof, may take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). In one example, selected components of the transceiver module can be located in a cloud radio access network (C-RAN). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules can also be implemented in software for execution by various types of processors. An identified module of executable code may, for instance, comprise one or more physical or logical blocks of computer instructions, which may, for instance, be organized as an object, procedure, or function. Nevertheless, the executables of an identified module may not be physically located together, but may comprise disparate instructions stored in different locations which, when joined logically together, comprise the module and achieve the stated purpose for the module.

Indeed, a module of executable code can be a single instruction, or many instructions, and may even be distributed over several different code segments, among different programs, and across several memory devices. Similarly, operational data can be identified and illustrated herein within modules, and may be embodied in any suitable form and organized within any suitable type of data structure. The operational data can be collected as a single data set, or may be distributed over different locations including over different storage devices, and may exist, at least partially, merely as electronic signals on a system or network. The modules may be passive or active, including agents operable to perform desired functions.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology can be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the technology be limited, except as by the claims set forth below.

What is claimed is:

1. A computer implemented method for moderating output confidence of output soft-information, comprising:
generating, using a processor, the output soft-information that is a measure of likelihood that a subset of bit sequence permutations correctly represents a bit sequence extracted from a radio signal received by a Multiple-Input and Multiple-Output (MIMO) detector or a Code Division Multiple Access (CDMA) detector;
calculating, using the processor, a distance of a bit sequence permutation to an expectation of correct bit sequences;
determining, using the processor, that the output confidence of the output soft-information warrants adjustment of the output confidence of the output soft-information based in part on the distance of the bit sequence to the expectation of correct bit sequences; and
adjusting, using the processor, the output confidence of the output soft-information based in part on the distance of the bit sequence to the expectation of correct bit sequences using an adjustment technique.

2. A method as in claim 1, wherein generating the output soft-information further comprises generating extrinsic output soft-information using new information.

3. A method as in claim 1, wherein generating the output soft-information further comprises generating full output soft-information using prior input soft-information.

4. A method as in claim 1, further comprising measuring the output confidence of the output soft-information by calculating a ratio for the distance of the bit sequence to the expectation of correct bit sequences.

5. A method as in claim 4, wherein calculating the ratio further comprises classifying an incorrect bits included in the subset of bit sequence permutations as noise that is added to additive white Gaussian noise.

6. A method as in claim 4, wherein the distance is a magnitude difference between the bit sequence to the expectation of correct bit sequences.

7. A method as in claim 4, wherein the distance is a magnitude squared difference between the bit sequence to the expectation of correct bit sequences.

8. A method as in claim 4, wherein the distance is an estimate of a magnitude or a magnitude squared, where magnitude=α [symbol] ax(|I|, |Q|)+β [symbol] in(|I|, |Q|), and where I and Q are real and imagine components, and a and 3 are constant coefficients adjusted for estimate accuracy.

9. A method as in claim 1, wherein the adjustment technique directly applies
$$\frac{1}{δ}$$
to output soft-information values.

10. A method as in claim 1, wherein the adjustment technique directly applies
$$\frac{1}{f ( δ )}$$
to output soft-information values.

11. A method as in claim 1, wherein the adjustment technique uses the distance in conjunction with a threshold to zero out the subset of bit sequence permutations.

12. A method as in claim 1, wherein the adjustment technique utilizes a transformation function to adjust output confidence of the output soft-information.

13. A method as in claim 12, wherein the transformation function passes the output confidence of the output soft-information through a shaping function.

14. A method as in claim 12, wherein the transformation function passes the output confidence of the output soft-information through a shaping look-up table.

15. A system for moderating output confidence of soft-information, comprising:
a processor;
a memory device including instructions that, when executed by the processor, cause the system to:
calculate the soft-information that is a measure of likelihood that an estimated correct bit represents a bit extracted from a radio signal received by a radio signal detector;
calculate a distance of the estimated correct bit to an expectation of correct bit sequences;
determine that the output confidence of the soft-information warrants adjustment of the output confidence of the soft-information based in part on the distance of the estimated correct bit sequence to the expectation of correct bit sequences; and
adjust the output confidence of the soft-information based in part on the distance of the estimated correct bit sequence to the expectation of correct bit sequences using an adjustment technique.

16. A system as in claim 15, wherein the radio signal detector is configured to separate the radio signal into multiple data streams.

17. A system as in claim 16, wherein the radio signal detector is further configured to use at least one of: Markov Chain Monet Carlo (MCMC), sphere-decoding, k-best, tree-search, interference cancellation, Minimum Mean-Squared Error (MMSE), or zero-forcing.

18. An apparatus comprising:
a memory controller having circuitry configured to:
calculate soft-information that is a measure of likelihood that a subset of bit sequence permutations correctly represents a bit sequence extracted from a radio signal received by a Multiple-Input and Multiple-Output (MIMO) detector or a Code Division Multiple Access (CDMA) detector;
calculate a distance of the bit sequence to an expectation of correct bit sequences;
determine that output confidence of the soft-information warrants adjustment of the output confidence of the soft-information based in part on the distance of the bit sequence to the expectation of correct bit sequences; and
adjust the output confidence of the soft-information based in part on the distance of the bit sequence to the expectation of correct bit sequences using a scaling function.

19. An apparatus of claim 18, wherein the scaling function is a linear scaling function.

20. An apparatus of claim 18, wherein the scaling function is a polynomial scaling function.
